(19) United States
(12) Patent Application Publication
(10) Pub. No.: US 2025/0350994 A1
(43) Pub. Date: Nov. 13, 2025

(54) JITTER-AWARE USER EQUIPMENT OPERATIONS

(71) Applicant: Apple Inc., Cupertino, CA (US)

(72) Inventors: Ping-Heng Kuo, London (GB); Fangli Xu, Beijing (CN); Haijing Hu, Los Gatos, CA (US); Naveen Kumar R. Palle Venkata, San Diego, CA (US); Ralf Rossbach, Munich (DE); Peng Cheng, Beijing (CN); Yuqin Chen, Beijing (CN)

(73) Assignee: Apple Inc., Cupertino, CA (US)

(21) Appl. No.: 19/173,709

(22) Filed: Apr. 8, 2025

Related U.S. Application Data
(60) Provisional application No. 63/644,347, filed on May 8, 2024.

(51) Int. Cl. H04W 28/02; H04W 28/06

(52) U.S. Cl. CPC H04W 28/0236; H04W 28/06

(57) ABSTRACT

The present application relates to devices and components including apparatus, systems, and methods to provide jitter-aware user equipment operations in wireless communication systems.

### CROSS-REFERENCE TO RELATED APPLICATION

This application claims priority to U.S. provisional application No. 63/644,347, entitled “Jitter-Aware User Equipment Operations,” filed on May 8, 2024, the disclosure of which is incorporated by reference herein in its entirety for all purposes.

### TECHNICAL FIELD

The present application relates to the field of wireless technologies and, in particular, to jitter-aware user equipment operations.

### BACKGROUND

Third Generation Partnership Project (3GPP) networks have developed to allow devices to establish connections with user equipments (UEs) of the network. These devices can be referred to as tethered devices. The tethered devices can exchange data with the UEs to utilize services of the 3GPP networks. In some embodiments, the tethered devices can capture data and transmit packets of the data to the UEs to utilize services of the 3GPP networks. Further, the data provided by the tethered devices can have a destination outside of the 3GPP network, where the 3GPP network can be utilized to provide the data to the destination.

### BRIEF DESCRIPTION OF THE DRAWINGS

FIG. 1 illustrates a network environment in accordance with some embodiments.

FIG. 2 illustrates a user equipment in accordance with some embodiments.

FIG. 3 illustrates a network device in accordance with some embodiments.

FIG. 4 illustrates an example end-to-end packet delivery arrangement in accordance with some embodiments.

FIG. 5 illustrates example delay representation in accordance with some embodiments.

FIG. 6 illustrates a first portion of an example network arrangement with a personal IoT network in accordance with some embodiments.

FIG. 7 illustrates a second portion of the example network arrangement in accordance with some embodiments.

FIG. 8 illustrates an example procedure illustrating the first approach in accordance with some embodiments.

FIG. 9 illustrates an example signal repetition representation in accordance with some embodiments.

FIG. 10 illustrates example repetition arrangement in accordance with some embodiments.

FIG. 11 illustrates an example procedure in accordance with some embodiments.

FIG. 12 illustrates an example procedure in accordance with some embodiments.

FIG. 13 illustrates an example procedure in accordance with some embodiments.

### DETAILED DESCRIPTION

The following detailed description refers to the accompanying drawings. The same reference numbers may be used in different drawings to identify the same or similar elements. In the following description, for purposes of explanation and not limitation, specific details are set forth such as particular structures, architectures, interfaces, techniques, etc. in order to provide a thorough understanding of the various aspects of various embodiments. However, it will be apparent to those skilled in the art having the benefit of the present disclosure that the various aspects of the various embodiments may be practiced in other examples that depart from these specific details. In certain instances, descriptions of well-known devices, circuits, and methods are omitted so as not to obscure the description of the various embodiments with unnecessary detail. For the purposes of the present document, the phrase “A or B” means (A), (B), or (A and B); and the phrase “based on A” means “based at least in part on A,” for example, it could be “based solely on A” or it could be “based in part on A.”

The following is a glossary of terms that may be used in this disclosure.

The term “circuitry” as used herein refers to, is part of, or includes hardware components such as an electronic circuit, a logic circuit, a processor (shared, dedicated, or group) or memory (shared, dedicated, or group), an application specific integrated circuit (ASIC), a field-programmable device (FPD) (e.g., a field-programmable gate array (FPGA), a programmable logic device (PLD), a complex PLD (CPLD), a high-capacity PLD (HCPLD), a structured ASIC, or a programmable system-on-a-chip (SoC)), digital signal processors (DSPs), etc., that are configured to provide the described functionality. In some embodiments, the circuitry may execute one or more software or firmware programs to provide at least some of the described functionality. The term “circuitry” may also refer to a combination of one or more hardware elements (or a combination of circuits used in an electrical or electronic system) with the program code used to carry out the functionality of that program code. In these embodiments, the combination of hardware elements and program code may be referred to as a particular type of circuitry.

The term “processor circuitry” as used herein refers to, is part of, or includes circuitry capable of sequentially and automatically carrying out a sequence of arithmetic or logical operations, or recording, storing, or transferring digital data. The term “processor circuitry” may refer an application processor, baseband processor, a central processing unit (CPU), a graphics processing unit, a single-core processor, a dual-core processor, a triple-core processor, a quad-core processor, or any other device capable of executing or otherwise operating computer-executable instructions, such as program code, software modules, or functional processes.

The term “interface circuitry” as used herein refers to, is part of, or includes circuitry that enables the exchange of information between two or more components or devices. The term “interface circuitry” may refer to one or more hardware interfaces, for example, buses, I/O interfaces, peripheral component interfaces, network interface cards, or the like.

The term “user equipment” or “UE” as used herein refers to a device with radio communication capabilities and may describe a remote user of network resources in a communications network. The term “user equipment” or “UE” may be considered synonymous to, and may be referred to as, client, mobile, mobile device, mobile terminal, user terminal, mobile unit, mobile station, mobile user, subscriber, user, remote station, access agent, user agent, receiver, radio equipment, reconfigurable radio equipment, reconfigurable mobile device, etc. Furthermore, the term “user equipment” or “UE” may include any type of wireless/wired device or any computing device including a wireless communications interface.

The term “computer system” as used herein refers to any type interconnected electronic devices, computer devices, or components thereof. Additionally, the term “computer system” or “system” may refer to various components of a computer that are communicatively coupled with one another. Furthermore, the term “computer system” or “system” may refer to multiple computer devices or multiple computing systems that are communicatively coupled with one another and configured to share computing or networking resources.

The term “resource” as used herein refers to a physical or virtual device, a physical or virtual component within a computing environment, or a physical or virtual component within a particular device, such as computer devices, mechanical devices, memory space, processor/CPU time, processor/CPU usage, processor and accelerator loads, hardware time or usage, electrical power, input/output operations, ports or network sockets, channel/link allocation, throughput, memory usage, storage, network, database and applications, workload units, or the like. A “hardware resource” may refer to compute, storage, or network resources provided by physical hardware element(s). A “virtualized resource” may refer to compute, storage, or network resources provided by virtualization infrastructure to an application, device, system, etc. The term “network resource” or “communication resource” may refer to resources that are accessible by computer devices/systems via a communications network. The term “system resources” may refer to any kind of shared entities to provide services, and may include computing or network resources. System resources may be considered as a set of coherent functions, network data objects or services, accessible through a server where such system resources reside on a single host or multiple hosts and are clearly identifiable.

The term “channel” as used herein refers to any transmission medium, either tangible or intangible, which is used to communicate data or a data stream. The term “channel” may be synonymous with or equivalent to “communications channel,” “data communications channel,” “transmission channel,” “data transmission channel,” “access channel,” “data access channel,” “link,” “data link,” “carrier,” “radio-frequency carrier,” or any other like term denoting a pathway or medium through which data is communicated. Additionally, the term “link” as used herein refers to a connection between two devices for the purpose of transmitting and receiving information.

The terms “instantiate,” “instantiation,” and the like as used herein refers to the creation of an instance. An “instance” also refers to a concrete occurrence of an object, which may occur, for example, during execution of program code.

The term “connected” may mean that two or more elements, at a common communication protocol layer, have an established signaling relationship with one another over a communication channel, link, interface, or reference point.

The term “network element” as used herein refers to physical or virtualized equipment or infrastructure used to provide wired or wireless communication network services. The term “network element” may be considered synonymous to or referred to as a networked computer, networking hardware, network equipment, network node, virtualized network function, or the like.

The term “information element” refers to a structural element containing one or more fields. The term “field” refers to individual contents of an information element, or a data element that contains content. An information element may include one or more additional information elements.

The term “based at least in part on” as used herein may indicate that an item is based solely on another item and/or an item is based on another item and one or more additional items. For example, item 1 being determined based at least in part on item 2 may indicate that item 1 is determined based solely on item 2 and/or is determined based on item 2 and one or more other items in embodiments.

In Third Generation Partnership Project (3GPP) networks, devices can establish connections with a user equipment (UE) of the network and transmits packets of data to the UE for utilizing services of the network and/or for providing to a destination via the network. The packets transmitted from the devices can be delayed (which can be referred to as jitter). This delay can cause issues, such as the packets arriving at the UE without having time for the packets to be forwarded without expiring.

Approaches described herein can allow a UE to autonomously address this delay that can occur when the devices transmit packets to the UE. The UE addressing the delay can provide improved service for the devices while limiting data transmission that would be required for having other elements of the network address the delay (such as the UE having to provide delay information to the other elements of the network to address the delay).

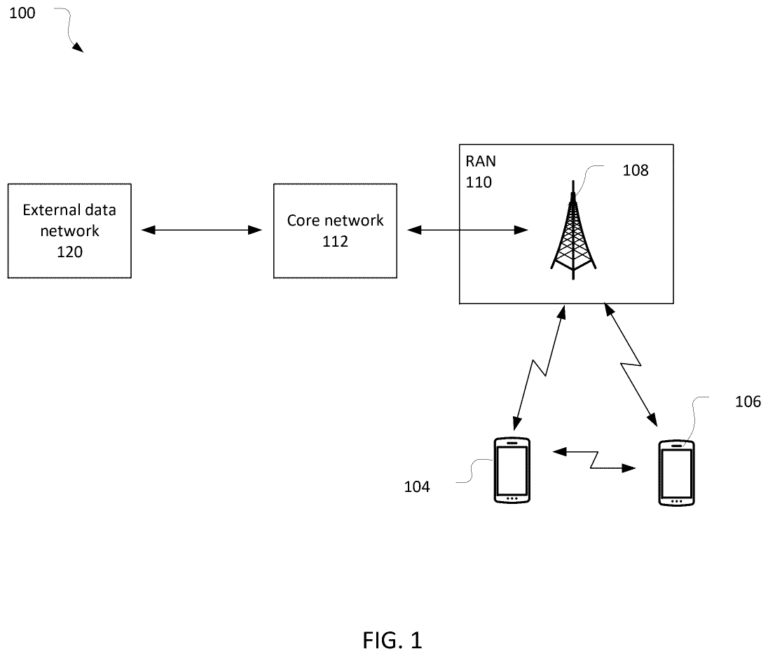

FIG. 1 illustrates a network environment 100 in accordance with some embodiments. The network environment 100 may include a user equipment (UE) 104 communicatively coupled with a base station 108 of a radio access network (RAN) 110. The UE 104 and the base station 108 may communicate over air interfaces compatible with 3GPP TSs such as those that define a Fifth Generation (5G) new radio (NR) system or a later system. The base station 108 may provide user plane and control plane protocol terminations toward the UE 104.

In some embodiments, the UE 104 and base station 108 may establish data radio bearers (DRBs) to support transmission of data over a wireless link between the two nodes. In one example, these DRBs may be used for traffic from extended reality (XR) applications that contains a large amount of data conveying real and virtual images and audio for presentation to a user.

The network environment 100 may further include a core network 112. For example, the core network 112 may comprise a 5th Generation Core network (5GC) or later generation core network. The core network 112 may be coupled to the base station 108 via a fiber optic or wireless backhaul. The core network 112 may provide functions for the UE 104 via the base station 108. These functions may include managing subscriber profile information, subscriber location, authentication of services, or switching functions for voice and data sessions.

In some embodiments, the network environment 100 may also include UE 106. The UE 106 may be coupled with the UE 104 via a sidelink interface. In some embodiments, the UE 106 may act as a relay node to communicatively couple the UE 104 to the RAN 110. In other embodiments, the UE 106 and the UE 104 may represent end nodes of a communication link. For example, the UEs 104 and 106 may exchange data with one another.

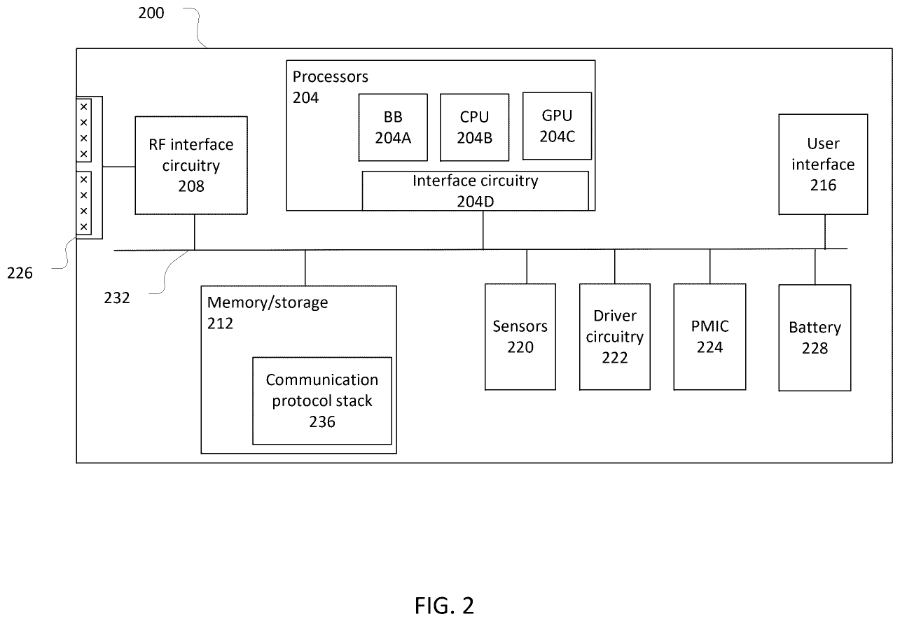

FIG. 2 illustrates a UE 200 in accordance with some embodiments. The UE 200 may be similar to and substantially interchangeable with UE 104 or 106.

The UE 200 may be any mobile or non-mobile computing device, such as, for example, mobile phones, computers, tablets, industrial wireless sensors (for example, microphones, carbon dioxide sensors, pressure sensors, humidity sensors, thermometers, motion sensors, accelerometers, laser scanners, fluid level sensors, inventory sensors, electric voltage/current meters, or actuators), video surveillance/monitoring devices (for example, cameras or video cameras), wearable devices (for example, a smart watch), or Internet-of-things devices.

The UE 200 may include processors 204, RF interface circuitry 208, memory/storage 212, user interface 216, sensors 220, driver circuitry 222, power management integrated circuit (PMIC) 224, antenna 226, and battery 228. The components of the UE 200 may be implemented as integrated circuits (ICs), portions thereof, discrete electronic devices, or other modules, logic, hardware, software, firmware, or a combination thereof. The block diagram of FIG. 2 is intended to show a high-level view of some of the components of the UE 200. However, some of the components shown may be omitted, additional components may be present, and different arrangement of the components shown may occur in other implementations.

The components of the UE 200 may be coupled with various other components over one or more interconnects 232, which may represent any type of interface, input/output, bus (local, system, or expansion), transmission line, trace, or optical connection that allows various circuit components (on common or different chips or chipsets) to interact with one another.

The processors 204 may include processor circuitry such as, for example, baseband processor circuitry (BB) 204A, central processor unit circuitry (CPU) 204B, and graphics processor unit circuitry (GPU) 204C. The processors 204 may include any type of circuitry or processor circuitry that executes or otherwise operates computer-executable instructions, such as program code, software modules, or functional processes from memory/storage 212 to cause the UE 200 to perform delay-adaptive operations as described herein. The processors 204 may also include interface circuitry 204D to communicatively couple the processor circuitry with one or more other components of the UE 200.

In some embodiments, the baseband processor circuitry 204A may access a communication protocol stack 236 in the memory/storage 212 to communicate over a 3GPP compatible network. In general, the baseband processor circuitry 204A may access the communication protocol stack 236 to: perform user plane functions at a PHY layer, MAC layer, RLC layer, PDCP layer, SDAP layer, and PDU layer; and perform control plane functions at a PHY layer, MAC layer, RLC layer, PDCP layer, RRC layer, and a NAS layer. In some embodiments, the PHY layer operations may additionally/alternatively be performed by the components of the RF interface circuitry 208.

The baseband processor circuitry 204A may generate or process baseband signals or waveforms that carry information in 3GPP-compatible networks. In some embodiments, the waveforms for NR may be based on cyclic prefix OFDM (CP-OFDM) in the uplink or downlink, and discrete Fourier transform spread OFDM (DFT-S-OFDM) in the uplink.

The memory/storage 212 may include one or more non-transitory, computer-readable media that includes instructions (for example, communication protocol stack 236) that may be executed by one or more of the processors 204 to cause the UE 200 to perform various delay-adaptive operations described herein.

The memory/storage 212 includes any type of volatile or non-volatile memory that may be distributed throughout the UE 200. In some embodiments, some of the memory/storage 212 may be located on the processors 204 themselves (for example, memory/storage 212 may be part of a chipset that corresponds to the baseband processor circuitry 204A), while other memory/storage 212 is external to the processors 204 but accessible thereto via a memory interface. The memory/storage 212 may include any suitable volatile or non-volatile memory such as, but not limited to, dynamic random access memory (DRAM), static random access memory (SRAM), erasable programmable read only memory (EPROM), electrically erasable programmable read only memory (EEPROM), Flash memory, solid-state memory, or any other type of memory device technology.

The RF interface circuitry 208 may include transceiver circuitry and a radio frequency front module (RFEM) that allows the UE 200 to communicate with other devices over a radio access network. The RF interface circuitry 208 may include various elements arranged in transmit or receive paths. These elements may include, for example, switches, mixers, amplifiers, filters, synthesizer circuitry, and control circuitry.

In the receive path, the RFEM may receive a radiated signal from an air interface via antenna 226 and proceed to filter and amplify (with a low-noise amplifier) the signal. The signal may be provided to a receiver of the transceiver that down-converts the RF signal into a baseband signal that is provided to the baseband processor of the processors 204.

In the transmit path, the transmitter of the transceiver up-converts the baseband signal received from the baseband processor and provides the RF signal to the RFEM. The RFEM may amplify the RF signal through a power amplifier prior to the signal being radiated across the air interface via the antenna 226.

In various embodiments, the RF interface circuitry 208 may be configured to transmit/receive signals in a manner compatible with NR access technologies.

The antenna 226 may include antenna elements to convert electrical signals into radio waves to travel through the air and to convert received radio waves into electrical signals. The antenna elements may be arranged into one or more antenna panels. The antenna 226 may have antenna panels that are omnidirectional, directional, or a combination thereof to enable beamforming and multiple input, multiple output communications. The antenna 226 may include microstrip antennas, printed antennas fabricated on the surface of one or more printed circuit boards, patch antennas, or phased array antennas. The antenna 226 may have one or more panels designed for specific frequency bands including bands in FR1 or FR2.

The user interface 216 includes various input/output (I/O) devices designed to enable user interaction with the UE 200. The user interface 216 includes input device circuitry and output device circuitry. Input device circuitry includes any physical or virtual means for accepting an input including, inter alia, one or more physical or virtual buttons (for example, a reset button), a physical keyboard, keypad, mouse, touchpad, touchscreen, microphones, scanner, headset, or the like. The output device circuitry includes any physical or virtual means for showing information or otherwise conveying information, such as sensor readings, actuator position(s), or other like information. Output device circuitry may include any number or combinations of audio or visual display, including, inter alia, one or more simple visual outputs/indicators (for example, binary status indicators such as light emitting diodes (LEDs) and multi-character visual outputs, or more complex outputs such as display devices or touchscreens (for example, liquid crystal displays (LCDs), LED displays, quantum dot displays, and projectors), with the output of characters, graphics, multimedia objects, and the like being generated or produced from the operation of the UE 200.

The sensors 220 may include devices, modules, or subsystems whose purpose is to detect events or changes in their environment and send the information (sensor data) about the detected events to some other device, module, or subsystem. Examples of such sensors include inertia measurement units comprising accelerometers, gyroscopes, or magnetometers; microelectromechanical systems or nanoelectromechanical systems comprising 3-axis accelerometers, 3-axis gyroscopes, or magnetometers; level sensors; flow sensors; temperature sensors (for example, thermistors); pressure sensors; barometric pressure sensors; gravimeters; altimeters; image capture devices (for example, cameras or lensless apertures); light detection and ranging sensors; proximity sensors (for example, infrared radiation detector and the like); depth sensors; ambient light sensors; ultrasonic transceivers; and microphones or other like audio capture devices.

The driver circuitry 222 may include software and hardware elements that operate to control particular devices that are embedded in the UE 200, attached to the UE 200, or otherwise communicatively coupled with the UE 200. The driver circuitry 222 may include individual drivers allowing other components to interact with or control various input/output (I/O) devices that may be present within, or connected to, the UE 200. For example, driver circuitry 222 may include a display driver to control and allow access to a display device, a touchscreen driver to control and allow access to a touchscreen interface, sensor drivers to obtain sensor readings of sensors 220 and control and allow access to sensors 220, drivers to obtain actuator positions of electro-mechanic components or control and allow access to the electro-mechanic components, a camera driver to control and allow access to an embedded image capture device, audio drivers to control and allow access to one or more audio devices.

The PMIC 224 may manage power provided to various components of the UE 200. In particular, with respect to the processors 204, the PMIC 224 may control power-source selection, voltage scaling, battery charging, or DC-to-DC conversion.

A battery 228 may power the UE 200, although in some examples the UE 200 may be mounted deployed in a fixed location and may have a power supply coupled to an electrical grid. The battery 228 may be a lithium ion battery, a metal-air battery, such as a zinc-air battery, an aluminum-air battery, a lithium-air battery, and the like. In some implementations, such as in vehicle-based applications, the battery 228 may be a typical lead-acid automotive battery.

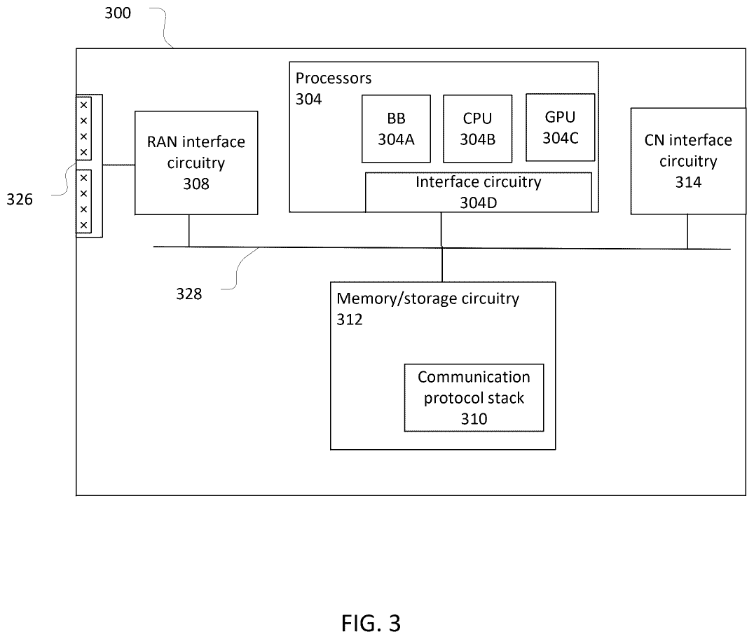

FIG. 3 illustrates a network device 300 in accordance with some embodiments. The network device 300 may be similar to and substantially interchangeable with base station 108 or a device of the core network 112 or external data network 120.

The network device 300 may include processors 304, RF interface circuitry 308 (if implemented as a base station), core network (CN) interface circuitry 314, memory/storage circuitry 312, and antenna structure 326.

The components of the network device 300 may be coupled with various other components over one or more interconnects 328.

The processors 304, RF interface circuitry 308, memory/storage circuitry 312 (including communication protocol stack 310), antenna structure 326, and interconnects 328 may be similar to like-named elements shown and described with respect to FIG. 2.

The processors 304 may include processor circuitry such as, for example, baseband processor circuitry (BB) 304A, central processor unit circuitry (CPU) 304B, and graphics processor unit circuitry (GPU) 304C. The processors 304 may include any type of circuitry or processor circuitry that executes or otherwise operates computer-executable instructions, such as program code, software modules, or functional processes from memory/storage circuitry 312 to cause the network device 300 to perform operations described herein. The processors 304 may also include interface circuitry 304D to communicatively couple the processor circuitry with one or more other components of the network device 300.

The CN interface circuitry 314 may provide connectivity to a core network, for example, a 5th Generation Core network (5GC) using a 5GC-compatible network interface protocol such as carrier Ethernet protocols, or some other suitable protocol. Network connectivity may be provided to/from the network device 300 via a fiber optic or wireless backhaul. The CN interface circuitry 314 may include one or more dedicated processors or FPGAs to communicate using one or more of the aforementioned protocols. In some implementations, the CN interface circuitry 314 may include multiple controllers to provide connectivity to other networks using the same or different protocols.

In fifth generation (5G)/sixth generation (6G) use cases, typically it is assumed that the uplink/sidelink information source (e.g., Application layer) is co-located with the modem in the same device (i.e., the UE). Thus, the delay experienced by an uplink packet before reaching the UE modem is negligible.

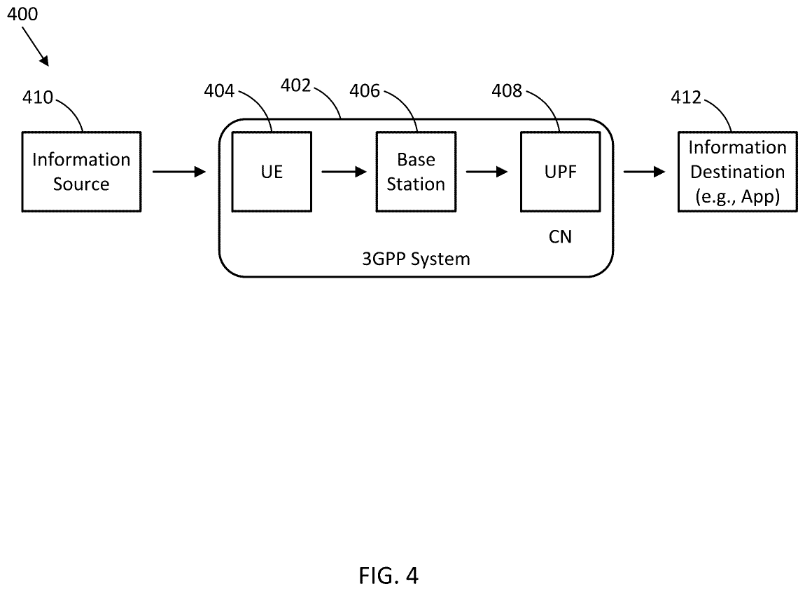

For 5G/6G, there are more use cases where the uplink/sidelink information is not generated at the UE. For example, the use cases can include one or more of the following use cases. A first use case may include tethering-based extended reality (XR devices). For example, the pose/gesture of the user is tracked by one or more wearables and/or sensors, that are not necessarily co-located with the UE modem. An example of tethering-based extended reality can be found at FIG. 4.2.2.4-2 of 3GPP technical report (TR 26.998). (3rd Generation Partnership Project; Technical Specification Group Services and System Aspects; Support of 5G Glass-type Augmented Reality/Mixed Reality (AR/MR) devices; (Release 18). (2024). 3GPP TR 26.998, 18.1.0).

A second use case may include digital twins/holographic communications. To reconstruct the digital version of the real-time ambient environment that captures all the fine details, instantaneous environmental attributes captured by cameras/sensors deployed at different places may have to be uploaded via the UE modem.

A third use case may include distributed computing. In 6G, the UE/network may offload some of the computing tasks (e.g., artificial intelligence (AI)/machine learning (ML) model training or inferences) to some third-party computing nodes. These external computing nodes may provide computing results to 6G UE via non-3GPP radio links.

A fourth use case may include industrial internet of things. The 3GPP system may act as bridges among time-sensitive network (TSN) devices.

There may be a stringent end-to-end delivery deadline. A packet delivered after its deadline may be equivalent to a lost packet.

FIG. 4 illustrates an example end-to-end packet delivery arrangement 400 in accordance with some embodiments. For example, the arrangement 400 illustrates an example signal flow of packet from an information source (such as a tethered device) to an information destination via a 3GPP network.

The arrangement 400 includes a 3GPP system 402 that can host a 3GPP network. The 3GPP system 402 may include a UE 404, a base station 406, and/or a user plane function (UPF) 408. The UE 404 may include one or more of the features of the UE 104 (FIG. 1), the UE 106 (FIG. 1), and/or the UE 200 (FIG. 2). The base station 406 may include one or more of the features of the base station 108 (FIG. 1) and/or the network device 300 (FIG. 3). The UPF 408 may be part of a core network (CN) of the 3GPP system 402.

The arrangement 400 includes an information source 410. The information source 410 may be a device that has a connection established with the UE 404, which can be referred to as a tethered device. The information source 410 may be able to capture information and generate packets of data for transmission to the UE 404. For example, the information source 410 may include a camera that can capture images of a surrounding environment, an audio capture device that can capture audio of a surrounding environment, and/or one or more other sensors that can capture information.

The arrangement 400 further includes an information destination 412. The information destination 412 may be another device located outside of the 3GPP system 402. The information destination 412 may host one or more applications that can utilize data generated by the information source 410.

The information source 410 may capture information and generate packets of data for transmission to the information destination 412. As the information source 410 does not have a direct connection with the information destination 412, the information source 410 may utilize the 3GPP system 402 to transmit the packets of data to the information destination 412.

The information source 410 may provide the packets of data to the UE 404 of the 3GPP system 402, where the information source 410 has a connection with the UE 404. The UE 404 may forward the packets to the base station 406 of the 3GPP system 402 to which the UE 404 is connected. The base station 406 may in turn forward the packets to the UPF 408 with which the base station 406 has a connection. Finally, the UPF 408 may forward the packets to the information destination 412. The transmissions of the packets between the elements of the arrangement 400 may have delay, as described further throughout this disclosure.

Transmissions between elements related to a 3GPP network may have a quality of service (QOS) requirement of packet delay budget (PDB). In legacy approaches, the packet delay budget (PDB) defined by 5G QoS can be partitioned into CN PDB and access network (AN) PDB.

The CN PDB may be the delay between any N6 termination point at the UPF (for any UPF that may possibly be selected for the packet data unit (PDU) session) and the fifth generation-access node (5G-AN). (The value of CN PDB is typically 1 millisecond (ms), 2 ms, or 5 ms). The AN PDB may be determined by subtracting a static value for CN PDB from a given PDB.

This legacy approach may be sufficient based on the assumption where the delay between an information source and a UE modem is negligible. However, in many of the use cases, the packet may have already experienced some severe jitter (for example, in non-3GPP radio links) even before reaching the UE modem, which can have significant impacts to the end-to-end delivery requirement. For example, the jitter may be caused by air interface delay in the non-3GPP radio links and/or application processing delay (e.g., encoding delay) at an output of the information source. To achieve timely end-to-end delivery, the actual PDB requirement may dynamically change among packets (or different subsets of packets) on the same flow, depending how much jitter the packet has experienced before reaching the UE (i.e., A larger jitter compresses the PDB available for 3GPP system).

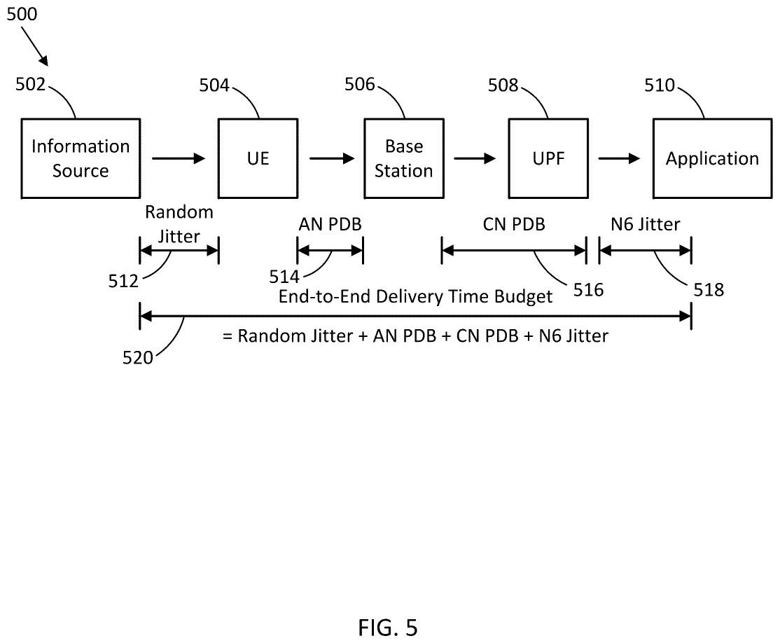

FIG. 5 illustrates example delay representation 500 in accordance with some embodiments. For example, the delay representation 500 illustrates delays that may occur for packet transmissions from an information source to an information destination via a 3GPP network.

The delay representation 500 includes an information source 502, a UE 504, a base station 506, a UPF 508, and an application 510 (where the application 510 is an information destination in the illustrated embodiment). The information source 502 may include one or more of the features of the information source 410 (FIG. 4). The UE 504 may include one or more of the features of the UE 404 (FIG. 4). The base station 506 may include one or more of the features of the base station 406 (FIG. 4). The UPF 508 may include one or more of the features of the UPF 408 (FIG. 4). The application 510 may include one or more of the features of, or may be hosted by, the information destination 412 (FIG. 4).

The information source 502 may have a connection with the UE 504. In some embodiments, the connection between the information source 502 and the UE 504 may be a wireless connection. The information source 502 may be referred to as a tethered device to the UE 504 based on the information source 502 having the connection with the UE 504. The information source 502 may capture information and generate packets of data for transmission to the application 510. As the information source 502 does not have a direct connection to the application 510, the information source 502 may transmit the packets of data to the UE 504 for forwarding to the application 510. Each of the packets transmitted from the information source 502 to the UE 504 may experience random jitter 512 (e.g., random amounts of delay). For example, the random jitter 512 may be caused by air interface delay in a non-3GPP link with the information source 502 and/or application processing delay (e.g., encoding delay) that may occur at an output of the information source 502, both of which can be random.

The UE 504 may receive the packets from the information source 502. The UE 504 may forward the received packets to the base station 506 for forwarding to the application 510. Each of the packets transmitted from the UE 504 to the base station 506 may have a AN PDB 514.

The base station 506 may receive the packets from the UE 504. The base station 506 may forward the received packets to the UPF 508. Each of the packets transmitted from the base station 506 to the UPF 508 may have a CN PDB 516.

The UPF 508 may receive the packets from the base station 506. The UPF 508 may forward the received packets to the application 510. Each of the packets transmitted from the UPF 508 to the application may experience N6 jitter 518 (e.g., amounts of delay when transferred via an N6 interface to application 510.

An end-to-end delivery time budget 520 may be defined for transmission of packets from the information source 502 to application 510. The end-to-end delivery time budget 520 may be defined to include the random jitter 512, the AN PDB 514, the CN PDB 516, and the N6 jitter 518. The end-to-end delivery time budget 520 may define a maximum time for packets of data to be transmitted from information source 502 to the application 510, where packets that take longer than the end-to-end delivery time budget 520 to be delivered from the information source 502 to the application 510 may be treated as expired or outdated. In order to meet this end-to-end delivery time budget 520, the time for the AN PDB 514 and/or the CN PDB 516 may be modified based on the amount of the random jitter 512 for the packets.

Non-3GPP delay budget in personal internet-of-thing (IoT) networks may also be considered. The jitter caused by the radio link between information source and the UE modem has also been a point of consideration relating to Personal IoT Network (PIN) in 3GPP.

In the reference architecture of PIN, the UE may act as a PIN Element with Gateway Capability (PEGC), which connects to a PIN Element (PINE) that can be a non-3GPP device. The PIN traffic can be delivered between PINE and 5GC. The delay in the interface between PINE and PEGC may be analogous to the jitter that occurs outside 3GPP system.

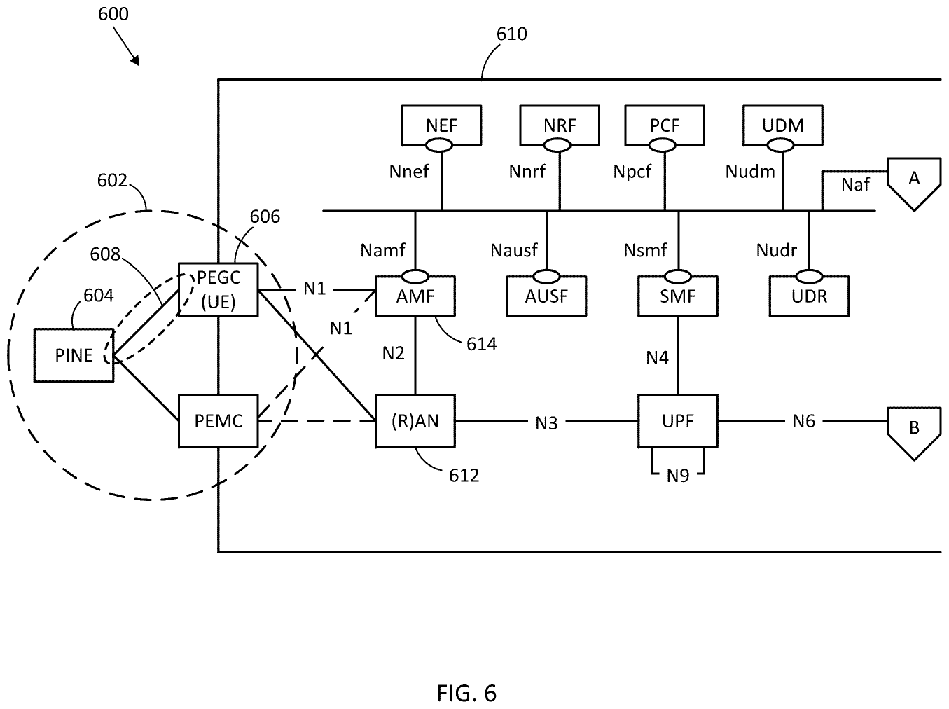

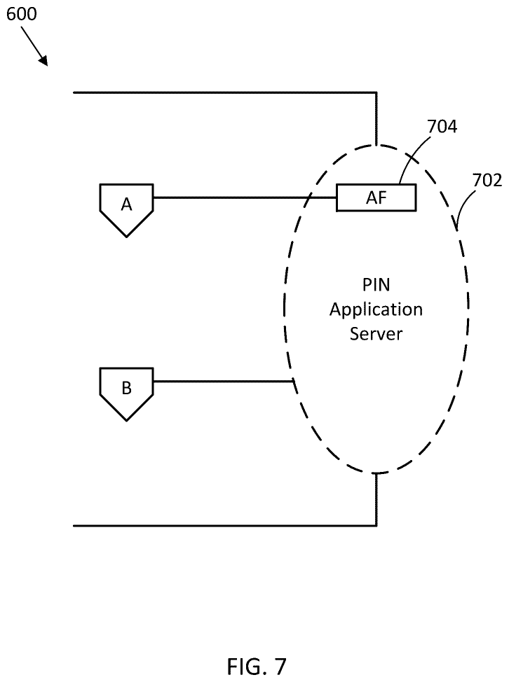

FIG. 6 illustrates a first portion of an example network arrangement 600 with a personal IoT network in accordance with some embodiments. FIG. 7 illustrates a second portion of the example network arrangement 600 in accordance with some embodiments.

The network arrangement 600 includes a PIN 602. The PIN 602 may include a PINE 604 and a PEGC 606. The PINE 604 may include one or more of the features of the information source 410 (FIG. 4) and/or the information source 502 (FIG. 5). The PINE 604 may be a non-3GPP device. The PEGC 606 may include one or more of the features of the UE 404 (FIG. 4) and/or the UE 504 (FIG. 5). The PEGC 606 may be part of a 3GPP network.

The PINE 604 may have a connection 608 with the PEGC 606. The PINE 604 may exchange data with the PEGC 606 via the connection 608, including the PINE 604 transmitting packets of data to the PEGC 606. The packets transmitted from the PINE 604 to the PEGC 606 may experience to delay (which may be referred to as jitter). The delay may be analogous to delay that occurs outside of the 3GPP system, such as the random jitter 512 (FIG. 5).

The PEGC 606 may provide a connection to a 3GPP network 610. The 3GPP network 610 may include one or more components of a 3GPP network 610, such as an access node 612 and/or an access and mobility management function (AMF) 614. Further, the 3GPP network 610 may include a CN. The 3GPP network 610 may have a connection to a PIN application server 702. The PIN application server 702 may operate an application function (AF) 704. The PINE 604 may exchange data with the PIN application server 702 via the 3GPP network 610.

The 5G core network may be able to adjust the PDB by taking the “non-3GPP delay” into account. For example, the following defines how a 5G core network may adjust a PDB by taking into account the non-3GPP delay:
Non-3GPP delay budget between PINE and PEGC
   For PIN related traffic via PEGC and 5GC, non-3GPP delay is the delay between the PEGC and the PINE. 5GC may need to be aware of the non-3GPP delay budget and compensate for this delay in 5GS. The compensation is achieved by reducing the PDB for the 3GPP network by the non-3GPP delay.
   If the PEGC supports requesting of the non-3GPP delay budget for a specific traffic flow, the PEGC may use the UE requested PDU Session Modification procedure to request a non-3GPP delay budget for a set of packet filters. Based on the (DNN, S-NSSAI) combination of the PDU Session, the SMF increases the dynamic CN PDB for the related GBR QoS flow by the requested non-3GPP delay budget according to operator policy and implementation and signals the updated dynamic CN PDB to NG-RAN. If the dynamic CN PDB changes in the SMF (e.g., when an I-UPF is inserted by the SMF), based on the (DNN, S-NSSAI) combination of the PDU Session, the SMF applies the non-3GPP delay budget again before signalling the dynamic CN PDB to NG-RAN. The non-3GPP delay budget does not impact the QoS flow binding in SMF.
   It is assumed that the PEGC will limit the frequency of triggering the UE-initiated PDU Session Modification request to provide the non-3GPP delay budget to the network to avoid unnecessary signalling.

The CN could provide dynamic CN PDB to a radio access network (RAN), and expect the RAN to fulfil the resultant (smaller) AN PDB. Even the UE may be able to request some PDB adjustment based on non-3GPP delay. It cannot do it too often due to signalling overhead concerns.

Handling of uplink jitter may be addressed by approaches described herein. In addition to the non-3GPP delay considered for PIN, the UE may be able to report uplink jitter information to the network via radio resource control (RRC) messages based on the framework of UE Assistance Information (UAI). Such information may be useful for the RAN to adjust certain radio configurations (e.g., configured grant and discontinuous reception (DRX)) to support the UL traffics. However, the UE can only report some jitter statistics relating to the traffic flow, such as maximum/minimum, range, and/or average jitter. This may not be feasible for the UE to report the jitter experienced by every single uplink packet (or a group of packets). Thus, when the delay budget of an uplink packet is severely reduced by a jitter, this may be infeasible to rely on the network to make sure such uplink packet can be transmitted within the end-to-end delivery time budget in the 3GPP system. This is impractical for the network to track the jitter experienced by every uplink packet.

To this end, we think some new mechanisms should be introduced in future releases (e.g., 6G). The mechanisms may allow the UE to evaluate the non-3GPP jitter that has been experienced by each of the incoming uplink packet, and/or allow the UE to perform jitter-aware operations on each of the incoming uplink/sidelink packet, to make sure the uplink/sidelink packet can be transmitted within the end-to-end delivery deadline, or to improve radio efficiency. Thus, rather than asking the UE to provide information relating to this jitter (e.g., non-3GPP delay in PIN, or UL jitter information), some autonomous UE behaviour can be quite useful.

This approaches described herein may address one or more of the following issues. A first issue is how to make UE access stratum (AS) aware of jitter experienced by each packet? A second issue is how to ensure/facilitate end-to-end delivery can be performed within the required delay budget in spite of the potential jitter occurred outside 3GPP system? A third issue is how to exploit the knowledge of jitter experienced by each packet to improve radio resource efficiency?

A first approach (which may be referred to as “approach 1” may relate to a high level concept. Approaches described herein includes a method that may be performed by a UE (such as the UE 104 (FIG. 1), the UE 106 (FIG. 1), the UE 200 (FIG. 2), the UE 404 (FIG. 4), and/or the UE 504 (FIG. 5)). The UE may receive a packet from an upper layer (e.g., APP) that may be hosted at a device that is tethered to the UE. Further, the UE may evaluate how much delay (i.e., jitter) has occurred in the link between the tethered-device and the UE. Based on the evaluated delay, the UE may determine if it should transmit this packet to RAN based on a default operation, or it should transmit this packet to RAN based on a special operation. The “special operation” may be used to facilitate packet delivery based on the delay requirement, or to facilitate improvement of radio efficiency. The “transmission” could be either uplink or Sidelink.

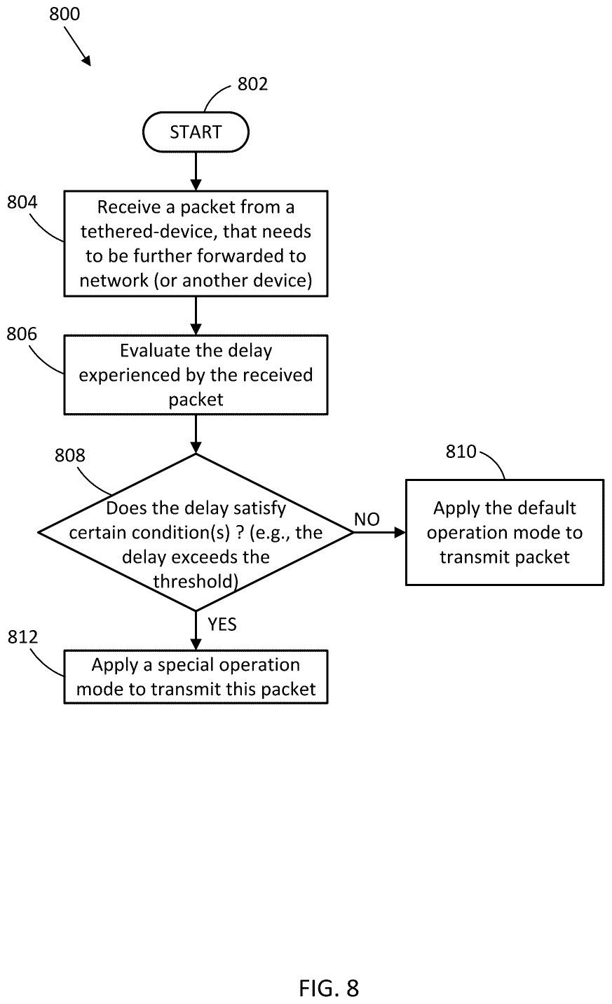

FIG. 8 illustrates an example procedure 800 illustrating the first approach in accordance with some embodiments. For example, a UE (such as the UE 104 (FIG. 1), the UE 106 (FIG. 1), the UE 200 (FIG. 2), the UE 404 (FIG. 4), and/or the UE 504 (FIG. 5)) may perform the procedure for a packet of data to determine which mode is to be applied to the packet.

The procedure 800 may start at 802. The UE may receive a packet from a tethered device in 804, where the packet is to be further forwarded to a network or another device. For example, the packet may be received from an information source (such as the information source 410 (FIG. 4) and/or the information source 502 (FIG. 5)) that is operating as a tethered device to UE. The packet may be scheduled to be forwarded to an information destination (such as the information destination 412 (FIG. 4)) and or an application (such as the application 510 (FIG. 5)). The packet may be received from an upper layer (such as an application layer) that may be hosted at a device that is tethered to UE.

The UE may evaluate delay experienced by the received packet in 806. For example, the UE may evaluate how much delay (such as jitter) that has occurred in the link between the tethered device and the UE. For example, the UE may determine the amount of random jitter (such as the random jitter 512 (FIG. 5)) between the tethered device and the UE.

The UE may determine whether the delay satisfies a certain condition or conditions in 808. The certain condition or conditions may be predefined or may be defined by the network. In some embodiments, the condition may be whether the delay exceeds a threshold amount of delay. The UE may determine whether a default operation mode or a special operation mode is to be utilized to transmit the packet to a base station based on whether the delay satisfies the certain condition or conditions. The default operation mode may be a normal operation for transmitting the packet to the base station. The special operation mode may differ from the normal operation, and may involve an operation that prioritizes the packets or otherwise addresses packets that have delay above the threshold. For example, the special operation mode may be used to facilitate packet delivery based on the delay requirement, or to facilitate improvement of radio efficiency. Approaches for the special operation mode are described further throughout this disclosure.

If the UE determines that the delay does not satisfy the certain condition or conditions, the UE may apply the default operation mode to the packet for transmission in 810. If the UE determines that the delay satisfies the certain condition or conditions, the UE may apply the special operation mode to the packet for transmission in 812. The transmission could be either an uplink transmission or sidelink transmission.

A second approach may address delay/jitter evaluation and operation mode determination.

In a first option, the UE may evaluate the delay/jitter experienced by an incoming packet. The UE may evaluate the delay based on at least one of the following embodiments. In a first embodiment, the delay may be evaluated based on the information provided by the application layer (e.g., the expected/theoretical arrival time). In a second embodiments, the delay may be evaluated based on the information provided by the tethered device (e.g., the expected/theoretical arrival time). In a second procedure, the delay may be evaluated based on the information provided by a core network function (e.g., the expected/theoretical arrival time). In a third embodiment, the delay may be evaluated based on a time stamp provided from the tethered device (e.g., indication of when this packet was first generated/transmitted by the tethered device. In a fourth embodiment, the delay may be evaluated based on the generalized precision time protocol (G-PTP) protocols.

Once the jitter/delay of an incoming packet is evaluated, the UE may further determine if a special operation mode should be applied to transmit this packet. In particular, the determination may be based on whether the delay/jitter of this packet satisfy certain conditions. The UE may determine whether the special operation mode is to be applied based on one or more of the following option. In a first option, the UE may determine whether the special operation mode is to be applied based on one or more conditions configured by the network (e.g., delay/jitter threshold). For example, radio resource control (RRC) configuration or non-access stratum (NAS) configuration. In a second option, the UE may determine whether the special operation mode is to be applied based on one or more conditions provided by the tethered device. In a third option, the UE may determine whether the special operation mode is to be applied based on one or more conditions provided by the application layer. In a fourth option, the UE may determine whether the special operation mode is to be applied based on one or more conditions provided by the core network. In a fifth option, how the UE determines whether the special operation mode is to be applied may be up to UE implementation.

In some embodiments, the rules for the UE to determine the packet forwarding treatment with regards to jitter/delay outside the 3GPP system could be provided via UE route selection policy (URSP) rules.

In some embodiments, it may be assumed that the UE knows the expected/theoretical packet arrival time (e.g., based on the information received from the application layer (APP)). The UE may start a timer at each of the expected/theoretical packet arrival time (For a periodic traffic flow, the UE may start such timer periodically for this flow).

If the corresponding packet arrives before its respective timer expiry, the UE may perform at least one of the following operations. A first operation may include stopping the timer upon arrival of the packet. A second operation may include determining the jitter based on how long the timer has been running. A third operation may include considering the jitter as zero. A fourth operation may include determining that a special mode should not be applied to transmit this packet.

If the corresponding packet does not arrive before its respective timer expiry, the UE may perform at least one of the following operations. A first operation may include discarding the packet directly (when it arrives). This could be the case when the jitter is even larger than the delay budget. A second operation may include considering the packet as a delay-critical packet (e.g., a delay-critical PDCP service data unit (SDU) and radio link control (RLC) SDU) (such as a delay-critical packet as defined in 3GPP technical specification (TS) 38.323 (3rd Generation Partnership Project; Technical Specification Group Radio Access Network; NR; Packet Data Convergence Protocol (PDCP) specification (Release 18). (2024). 3GPP TS 38.323, 18.1.0)). A third operation may include triggering a delay status report (DSR) (such as a DSR as defined in 3GPP TS 38.321 (3rd Generation Partnership Project; Technical Specification Group Radio Access Network; NR; Medium Access Control (MAC) protocol specification (Release 18). (2024). 3GPP TS 38.321, 18.1.0)) for the corresponding logical channel (LCH) or logical channel group (LCG). A fourth operation may include determining that a special mode should be applied to transmit this packet.

A third approach may address the special operation mode. If the UE determines that a special operation mode is to be utilized to process an incoming packet (whose delay/jitter satisfies specific conditions), one or more of the following operations may be applied.

In a first operation, the service data adaption protocol (SDAP) layer (or any protocol layer) of the UE may apply a special data radio bearer (DRB) mapping rule (that may be different to the default quality of service flow identifier (QFI) to DRB mapping), which may allow the UE to map this packet to a specific DRB. The base station (which may be a next generation NodeB (gNB)) may pre-configure which uplink DRB should be used for such a packet.

In a second operation, the SDAP layer (or any protocol layer) of the UE may apply a discarding mechanism, which may directly discard the incoming packet without further submitting the packet to the lower layer (i.e., the SDAP does not map this packet to any DRB).

In a third operation, the PDCP layer (or any protocol layer) of the UE may apply a special discard timer (the value of which could be pre-configured by the network) to the packet. The timer value may be smaller than a default discard timer value. The timer value could be zero, which means the PDCP layer may discard this packet directly.

In a fourth operation, the PDCP layer (or any protocol layer) of the UE may consider this packet as a delay-critical PDCP SDU. The other packets that are inter-dependent with this packet (e.g., belonging to the same PDU Set) may be considered as delay-critical PDCP SDUs together.

In a fifth operation, the PDCP layer (or any protocol layer) of the UE may duplicate this packet by submitting it to multiple RLC entities (if configured). The number of copies may depend on the value of evaluated delay/jitter.

In a sixth operation, the PDCP layer (or any protocol layer) of the UE may submit (re-route) this packet to a special RLC entity, assuming the DRB has two or more RLC entities. The two or more RLC entities may include a default one and a special one. In some embodiments of the sixth operation, the two or more RLC entities may correspond to LCHs with different configurations (e.g., different LCH priorities, different mapping restrictions). In some embodiments of the sixth operation, the two or more RLC entities may operate in different modes (e.g., acknowledged mode (AM) or unacknowledged mode (UM)). The UM may be applied to packets that have experienced large jitter/delay in order to reduce the latency. In some embodiments of the sixth operation, the two or more RLC entities may associate with different medium access control (MAC) entities for different cell groups (e.g., dual-connectivity).

In a seventh operation, the RLC layer (or any protocol layer) of the UE may prioritize this packet over at least one other packets in the queue, or de-prioritize this packet. When a radio resource is available in the lower layer, the UE may intentionally change the order of submitting this packet to the lower layers. For instance, by default the RLC layer may always prioritize RLC SDUs for retransmission over RLC SDUs for initial transmission, but if the UE determines to utilize a special operation to process this packet, the RLC layer may prioritize this packet over some other RLC SDUs for retransmission, even if this packet is for initial transmission.

In an eighth operation, the MAC layer (or any protocol layer) of the UE may adapt the usage of radio resource when transmitting this packet. In some embodiments of the seventh operation, the UE may apply autonomous repetition using resources in a configured grant (CG) configuration. In some embodiments of the eighth operation, the UE may apply autonomous repetition using resources in a different serving cells or in a different configured grant. In some embodiments of the eighth operation, the UE may apply different physical layer (PHY) parameters to perform transmission, such as power level, modulation and coding scheme (MCS), number of repetition, beam direction, and/or other PHY parameters.

In any of the operations above, the UE may only determine to utilize the special operation to process the incoming packet if the incoming packet is associated to one or more importance levels. For example, the UE may not utilize the special operation to process the incoming packet if it belongs to a PDU Set that is considered to be low importance.

A fourth approach may address the special operation mode: autonomous repetition by UE. An issue of hybrid automatic repeat request (HARQ) retransmission for packets with large jitter/delay may include when the UE transmits an uplink transport block (TB) including the packet on a physical uplink shared channel (PUSCH), it may further re-transmit the transport block if a retransmission grant is received from the base station (which may be a gNB).

However, it cannot be guaranteed that the base station is able to provide the retransmission grant in time (i.e., within the end-to-end delivery requirement). Before the packet arrives at the UE AS, a large portion of delay budget may already be consumed by jitter occurs outside of the 3GPP system. Thus, the remaining time available for HARQ retransmission may be quite short. Furthermore, the base station may not be aware of the jitter that has experienced by each individual packet, and therefore it cannot react accordingly. Repetition can be configured for default operation, wherein every packet can be repeated autonomously, but it may result in resource wastage as this is not always needed.

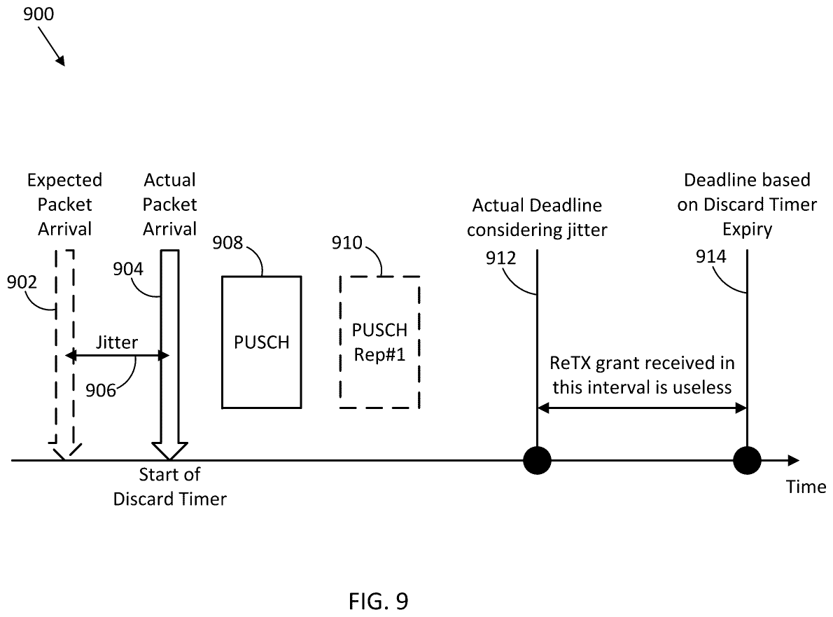

FIG. 9 illustrates an example signal repetition representation 900 in accordance with some embodiments. The representation 900 illustrates example considerations related to jitter that may be experienced by packets outside of the 3GPP system. For example, the representation 900 illustrates considerations that may be considered when receiving a packet.

The representation 900 includes an expected packet arrival 902. The expected packet arrival 902 may be a time that the UE expects the packet to arrive from a tethered device. The UE may determine the expected packet arrival 902 based on information received from the application layer. While the UE may expect the packet to arrive at the expected packet arrival 902, the packet may not arrive at the expected packet arrival 902.

The representation 900 includes an actual packet arrival 904. The actual packet arrival 904 may be a time when the packet actual arrives at the UE. There may be a delay between the actual packet arrival 904 and the expected packet arrival 902, where the delay may be referred to as jitter 906. The UE may start a discard timer for the packet at the actual packet arrival 904. The UE may be configured to discard the packet at the expiry of the discard timer.

The UE may generate and/or transmit a physical uplink shared channel (PUSCH) transmission 908 to a base station, where the PUSCH transmission includes the packet. The UE may determine whether to generate and/or transmit one or more repetitions of the PUSCH transmission, such as the first repetition 910.

The representation 900 includes an actual deadline 912 considering the jitter 906. The actual deadline 912 may be a deadline for transmission of the packet from the UE based on the expected packet arrival 902. For example, if the packet is transmitted from the UE after the actual deadline, the packet may not arrive at a destination in time, may be treated as expired or outdated, and may not be utilizable by the destination.

The representation 900 includes a deadline 914 based on the discard timer expiry. For example, the deadline 914 may be defined to be the expiration of the discard timer that was started at the actual packet arrival 904. The deadline 914 may occur after the actual deadline 912. When the deadline 914 occurs after the actual deadline 912, transmissions of the packet (either the PUSCH transmission or repetitions of the PUSCH transmission) transmitted by the UE after the actual deadline 912 and before the deadline 914 may not arrive at the destination and may be useless. Accordingly, any retransmission grants for transmissions of the packet between the actual deadline 912 and the deadline 914 may be useless since the packets may not arrive at the destination prior to expiration. In instances where the UE relies on the discard timer for defining a deadline for autonomous repetitions of the packet, the UE may transmit repetitions of the packet during time between the actual deadline 912 and the deadline 914, which results in a waste of resources since the repetitions will not be delivered in time. Accordingly, it can be beneficial to avoid retransmission of the packet between the actual deadline 912 and the deadline 914.

The UE may consider an uplink configured grant or a dynamic grant with multiple PUSCH occasions for the autonomous repetition. The UE can, based on knowledge of jitter experienced by a packet multiplexed into a configured grant, determine if it should use subsequent configured grant resources for repetition. In particular, if the experienced jitter is small, there is still plenty of remaining time available, repetition may not be needed as the UE may simply rely on retransmission grant from the base station. Further, if the experienced jitter is large, there is only marginal remaining time available, the UE may perform repetition autonomously by using the subsequent configured grant resource to ensure the packet can be transmitted correctly. The number of autonomous repetition to be performed, could be determined by the UE dynamically, based on, for example, how much jitter the packet has experienced. Alternatively, the number of autonomous repetitions to be performed could be fixed or pre-configured by the network. For example, as long as the jitter experienced by the packet exceeds a threshold, the UE may perform the transmission of the corresponding TB twice (one initial transmission plus one autonomous repetition).

In some embodiments, the SDAP/PDCP of the UE may map the packet to specific DRB or RLC, if the packet experiences jitter larger than a threshold (based on approaches described in earlier slides). In MAC, the autonomous repetition can be applied as long as the data from the LCH corresponding to this specific DRB/LCH is mapped to the uplink grant such as a configured grant configuration (e.g., based on pre-configured LCH mapping restrictions). This allows MAC to perform autonomous repetition without the knowledge of upper layer jitter.

An uplink control information (UCI) (akin to configured grant-uplink control information (CG-UCI) or unused transmission occasion-uplink control information (UTO-UCI)) may be included in the initial transmission (e.g., UCI-multiplexing in a first PUSCH transmission) to indicate at least one of the following elements. A first element that may be indicated by the UCI is whether repetition will be performed for this transmission on subsequent resources. A second element that may be indicated by the UCI is, if repetition is NOT to be performed, whether the remaining CG resources will be unused, or will be used new transmissions. A third element that may be indicated by the UCI is, if repetition is to be performed, how many repetition will be performed, and/or whether the remaining CG resources will be unused, or will be used new transmissions. A fourth element that may be indicated by the UCI is, if repetition is to be performed, the redundancy versions (RVs) of the TB to be transmitted in the repetition(s). A fifth element that may be indicated by the UCI is the value of a timer that starts with the PUSCH—the CG resources will be used for repetition while the timer is running. The UCI may be multiplexed in every CG resource to be used, and could be updated.

If repetition is to be performed, the HARQ process identifiers (PIDs) of some subsequent resources (e.g., subsequent CG occasions) may be switched from their default HARQ PIDs to the HARQ PID of the PUSCH where the repetition is to be performed, which allows the receiver to combine the TB correctly.

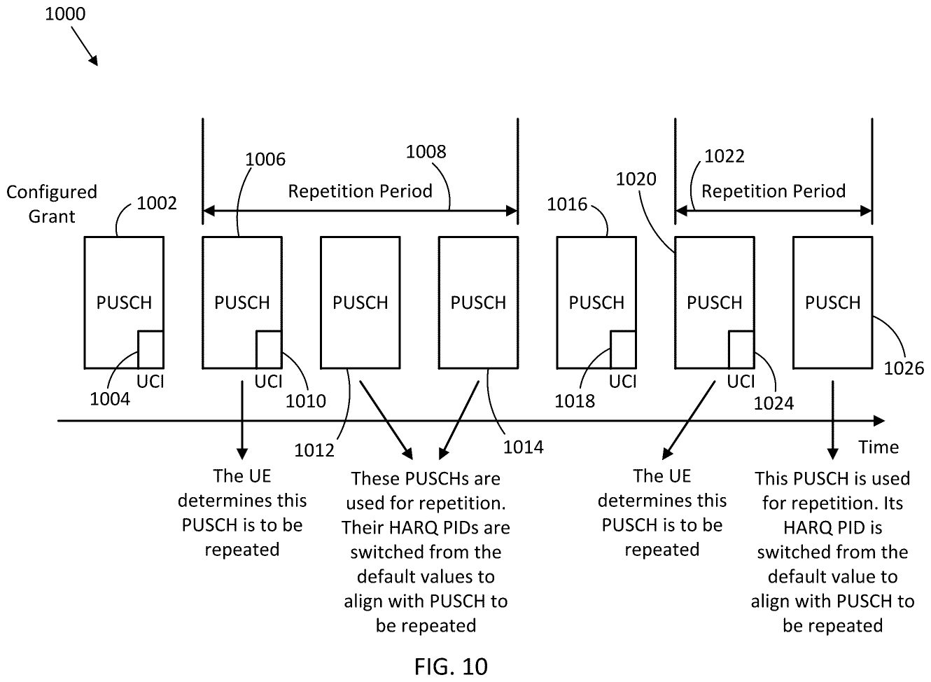

FIG. 10 illustrates example repetition arrangement 1000 in accordance with some embodiments. For example, the arrangement 1000 illustrates example PUSCH transmissions of packets by a UE and repetitions of the PUSCH transmissions by the UE in accordance with some embodiments. The UE may be configured with grants to transmit the PUSCH transmissions and the repetitions illustrated.

The arrangement 1000 may include a first PUSCH transmission 1002. The first PUSCH transmission 1002 may include a first packet. The UE may determine that repetitions are not to be generated and/or transmitted for the first PUSCH transmission 1002. The first PUSCH transmission 1002 may include a first UCI 1004. The first UCI 1004 may indicate any of the elements described above related to UCI for the first PUSCH transmission 1002.

The arrangement 1000 may include a second PUSCH transmission 1006. The second PUSCH transmission 1006 may include a second packet. The UE may determine that repetitions are to be generated and/or transmitted for the second PUSCH transmission 1006. Further, the UE may determine a number of repetitions and/or a repetition period 1008 for the repetitions. The second PUSCH transmission 1006 may include a second UCI 1010. The second UCI 1010 may indicate any of the elements described above related to UCI for the second PUSCH transmission 1006.

In the illustrated embodiment, the UE may determine to generate and/or transmit two repetitions for the second PUSCH transmission 1006. In particular, the UE may generate and/or transmit a first repetition 1012 and a second repetition 1014 of the second PUSCH transmission 1006. HARQ PIDs of the first repetition 1012 and the second repetition 1014 may be switched from default values to align with the second PUSCH transmission 1006. The first repetition 1012 and the second repetition 1014 may omit UCIs.

The arrangement 1000 may include a third PUSCH transmission 1016. The third PUSCH transmission 1016 may include a third packet. The UE may determine that repetitions are not to be generated and/or transmitted for the third PUSCH transmission 1016. The third PUSCH transmission 1016 may include a third UCI 1018. The third UCI 1018 may indicate any of the elements described above related to UCI for the third PUSCH transmission 1016.

The arrangement 1000 may include a fourth PUSCH transmission 1020. The fourth PUSCH transmission 1020 may include a fourth packet. The UE may determine that repetitions are to be generated and/or transmitted for the fourth PUSCH transmission 1020. Further, the UE may determine a number of repetitions and/or a repetition period 1022 for the repetitions. The fourth PUSCH transmission 1020 may include a fourth UCI 1024. The fourth UCI 1024 may indicate any of the elements described above related to UCI for the fourth PUSCH transmission 1020.

In the illustrated embodiment, the UE may determine to generate and/or transmit one repetition for the fourth PUSCH transmission 1020. In particular, the UE may generate and/or transmit a first repetition 1026 of the fourth PUSCH transmission 1020. A HARQ PID of the first repetition 1026 may be switched from a default value to align with the fourth PUSCH transmission 1020. The first repetition 1026 may omit a UCI.

This scheme could be an extension of multi-PUSCH CG that is specified for XR (in 3GPP TS 38.321 and 3GPP TS 38.331 (3^{rd} Generation Partnership Project; Technical Specification Group Radio Access Network; NR; Radio Resource Control (RRC) protocol specification (Release 18). (2024). 3GPP TS 38.331, 18.1.0) for Rel-18), which naturally comes with multiple transmission opportunities that could be used for repetition in an on-demand manner, as well as a UCI-signaling framework that could be reused. The UTO-UCI may be multiplexed in every PUSCH of a CG to indicate which CG resources of the Multi-PUSCH CG will be unused transmission occasions (UTO). This may allow the base station to know which CG resources will not be used by the UE, and hence the base station may allocate such resources to other UEs.

This framework can be extended to indicate which CG resources of the Multi-PUSCH CG will be used for autonomous repetition. This UCI can be multiplexed into the PUSCH wherein the TB is to be repeated. This UCI can be in a bitmap form, where each bit represents the usage of a subsequent CG resource, e.g., 0=used for new transmission, 1=used for repetition. This UCI can indicate a number of repetition to be performed (e.g., K>1). The gNB can e.g., assume the next K−1 CG occasions will be used for repetition of TB corresponding to the PUSCH where such UCI is received.

While the approaches described throughout this disclosure are described separately, it should be understood that one or more of the approaches can be implemented in embodiments. Accordingly, two or more of the approaches can be implemented in some embodiments and only one of the approaches can be implemented in other embodiments.

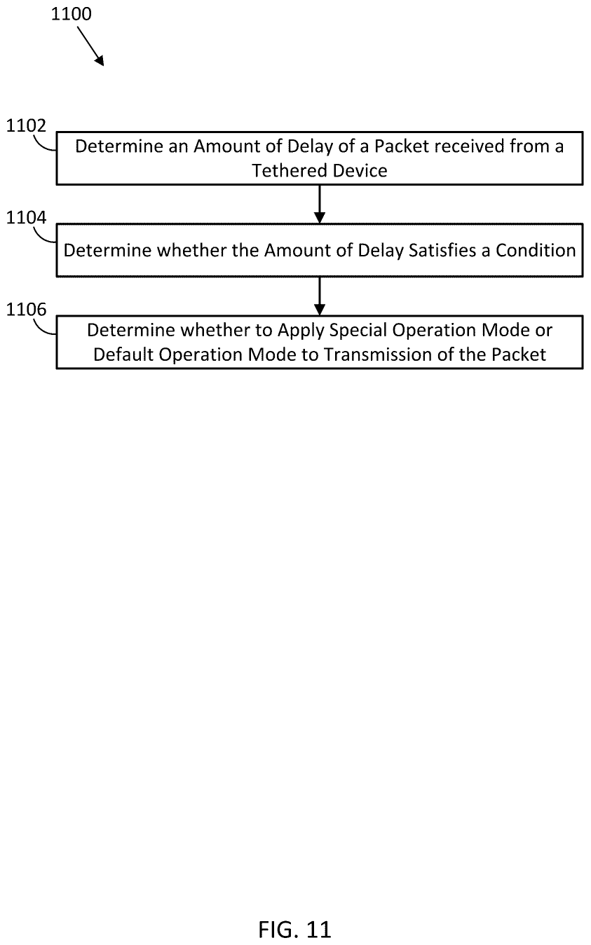

FIG. 11 illustrates an example procedure 1100 in accordance with some embodiments. The procedure 1100 may be performed to determine whether to apply special operation mode or default mode operation to transmission of a packet. The procedure 1100 may be performed by a UE, such as the UE 104 (FIG. 1), the UE 106 (FIG. 1), the UE 200 (FIG. 2), the UE 404 (FIG. 4), and/or the UE 504 (FIG. 5).

The procedure 1100 may include determining an amount of delay of a packet received from a tethered device in 1102. For example, the UE may receive a packet from a tethered device, such as the information source 410 (FIG. 4) and/or the information source 502 (FIG. 5). The UE may determine an amount of delay (which may be referred to as jitter) of the packet.

The procedure 1100 may include determining whether the amount of delay satisfies a condition in 1104. In some embodiments, determining whether the amount of delay satisfies the condition includes determining whether the amount of delay exceeds a threshold value. Further, the condition may be configured by a network, provided by the tethered device, provided by an application layer, provided by a core network, or configured by a user equipment implementation in some embodiments. In some embodiments, determination of whether the amount of delay satisfies the condition is based on information provided by an application layer, information provided by the tethered device, information provided by a core network function, a time stamp received from the tethered device, or generalized precision time protocols.

In some embodiments, determining whether the amount of delay satisfies the condition may include starting a count of a timer at an expected packet arrival time of the packet from the tethered device, determining whether the packet is received from the tethered device prior to expiry of the timer, and determining whether the amount of delay satisfies the condition based at least in part on whether the packet is received prior to the expiry of the timer.

In some of these embodiments, the packet may be determined to be received prior to expiry of the timer. In these embodiments, the procedure 1100 may further include stopping the timer upon receipt of the packet, determining the amount of delay based at least in part on a duration that the timer was counting until receipt of the packet, treating the amount of delay as zero, or determining that the default operation mode is to be applied to the transmission of the packet.

In some of these embodiments, the packet may be determined to be received after expiry of the timer. In these embodiments, the procedure 1100 may further include discarding the packet when the packet arrives, treating the packet as a delay-critical packet, triggering a DSR for a corresponding LCH or LCG, or determining that the special operation mode is to be applied.

In some embodiments, the procedure 1100 may further include determining whether the amount of delay exceeds a threshold, and determining whether to autonomously utilize subsequent CG resources for repetition of the packet based at least in part on the determination of whether the amount of delay exceeds the threshold. In some of these embodiments, the procedure 1100 may further include multiplexing a UCI element with the packet for an initial transmission of the packet. The UCI may indicate whether repetition will be performed for the packet on subsequent resources, whether remaining CG resources will be unused or used for other transmissions, whether redundancy versions of a transport block for the packet is to be transmitted in repetitions of the packet, or a value of a timer for one or more repetitions of the packet.

The procedure 1100 may include determining whether to apply special operation mode or default operation mode to transmission of the packet in 1106. For example, the UE may determine whether to apply special operation mode or default operation mode to transmission of the packet based at least in part on whether the amount of delay satisfies the condition.

In some embodiments, determining whether to apply the special operation mode or the default operation mode to transmission of the packet includes determining to apply the special operation mode to the packet. Based on the determination to apply the special operation mode to the packet, the procedure 1100 may include mapping the packet to a specific data resource bearer (DRB), discarding the packet, applying a special discard timer to the packet, treating the packet as a delay-critical packet data convergence protocol (PDCP) service data unit (SDU), submitting copies of the packet to multiple radio link control (RLC) entities, submitting the packet to a special RLC entity, or adapting radio resource usage for transmission of the packet.

In some of these embodiments, the procedure 1100 may further include submitting the packet to the special RLC entity. Two or more RLC entities may correspond to logical channels (LCHs) with different configurations, the two or more RLC entities including the special RLC entity, two or more RLC entities may operate in different modes, the two or more RLC entities including the special RLC entity and the special RLC entity operating in unacknowledged mode (UM), or two or more RLC entities may be associated with different medium access control entities (MAC) for different cell groups, the two or more RLC entities including the special RLC entity.

In some of these embodiments, the procedure 1100 may further include adapting the radio resource usage for transmission of the packet. Autonomous repetition using resources in a configured grant (CG) configuration may be applied, autonomous repetition using resources in a different CG configuration may be applied, or different physical layer (PHY) parameters to perform transmission of the packet may be applied.

Any one or more of the operations in FIG. 11 may be performed in a different order than shown and/or one or more of the operations may be performed concurrently in embodiments. Further, it should be understood that one or more of the operations may be omitted from and/or one or more additional operations may be added to the procedure 1100 in other embodiments.

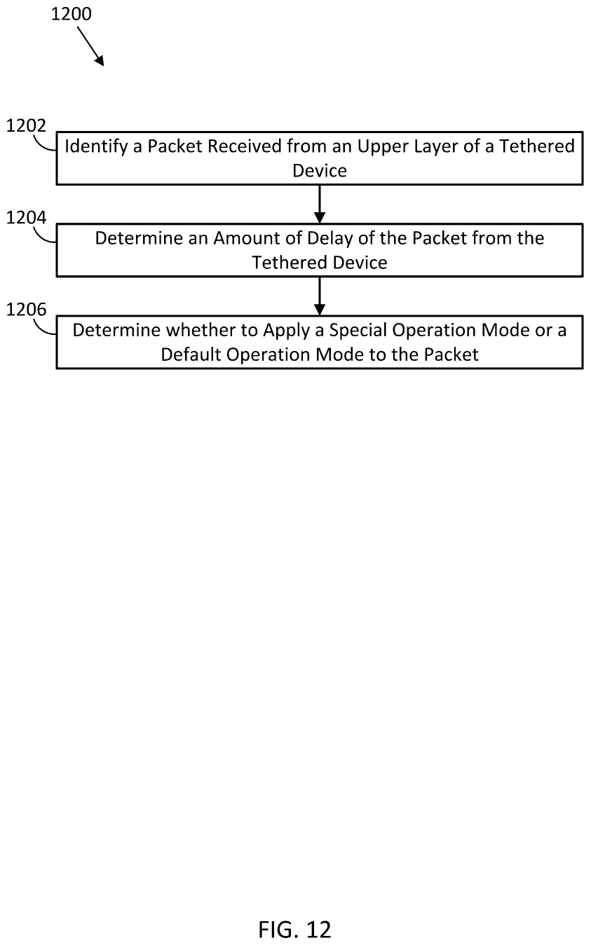

FIG. 12 illustrates an example procedure 1200 in accordance with some embodiments. The procedure 1200 may be performed to determine whether to apply special operation mode or default mode operation to transmission of a packet. The procedure 1200 may be performed by a UE, such as the UE 104 (FIG. 1), the UE 106 (FIG. 1), the UE 200 (FIG. 2), the UE 404 (FIG. 4), and/or the UE 504 (FIG. 5).

The procedure 1200 may include identifying a packet received from an upper layer of a tethered device in 1202. For example, the UE may identify a packet received from an upper layer of a tethered device, the packet to be forwarded to a network.

The procedure 1200 may include determining an amount of delay of the packet from the tethered device in 1204. In some embodiments, the procedure 1200 may further include determining whether the amount of delay exceeds a threshold, and determining whether to autonomously utilize subsequent configured grant (CG) resources for repetition of the packet based at least in part on the determination of whether the amount of delay exceeds the threshold.

The procedure 1200 may include determining whether to apply a special operation mode or a default operation mode to the packet in 1206. For example, the UE may determine whether to apply a special operation mode or a default operation mode to the packet for transmission of the packet to the network for transmission of the packet to the network.

In some embodiments, determining whether to apply the special operation mode or the default operation mode may include initiating a count of a timer at an expected packet arrival time for the packet, and determining whether the packet is received prior to an expiry of the timer.

In some embodiments, determining whether to apply the special operation mode or the default operation mode includes determining to apply the special operation mode to the packet. In some of these embodiments, based on the determination to apply the special operation mode, the procedure 1200 may further include mapping the packet to a specific data resource bearer (DRB), discarding the packet, applying a special discard timer to the packet, treating the packet as a delay-critical packet data convergence protocol (PDCP) service data unit (SDU), submitting copies of the packet to multiple radio link control (RLC) entities, submitting the packet to a special RLC entity, or adapting radio resource usage for transmission of the packet.

Any one or more of the operations in FIG. 12 may be performed in a different order than shown and/or one or more of the operations may be performed concurrently in embodiments. Further, it should be understood that one or more of the operations may be omitted from and/or one or more additional operations may be added to the procedure 1200 in other embodiments.

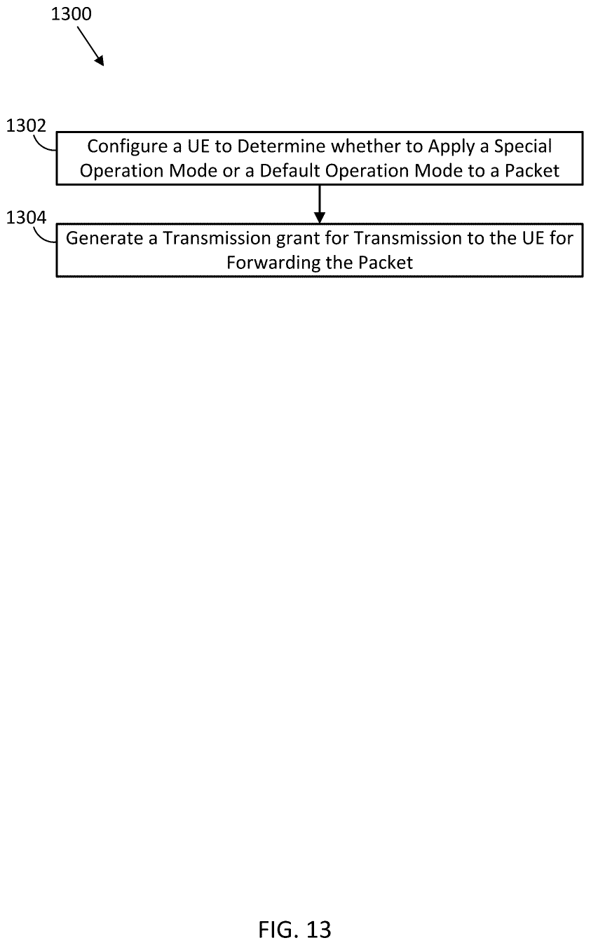

FIG. 13 illustrates an example procedure 1300 in accordance with some embodiments. The procedure 1300 may be performed to configure a UE to determine whether to apply a special operation mode or a default operation mode to a packet. The procedure 1300 may be performed by a base station, such as the base station 108 (FIG. 1), the network device 300 (FIG. 3), the base station 406 (FIG. 4), and/or the base station 506 (FIG. 5).

The procedure 1300 may include configuring a UE to determine whether to apply a special operation mode or a default operation mode to a packet in 1302. For example, the base station may configure a UE to determine whether to apply a special operation mode or a default operation mode to a packet received from a tethered device based at least in part on an amount of delay of the packet from the tethered device.

In some embodiments, the procedure 1300 may further include configuring the UE with information for determining the amount of delay or with one or more conditions for determining whether a condition is satisfied for applying the special operation mode.

The procedure 1300 may include generating a transmission grant for transmission to the UE for forwarding the packet in 1304.

In some embodiments, the procedure 1300 may further include identifying an uplink control information (UCI) element multiplexed with an initial transmission of the packet, and determining whether autonomous repetition is to be performed for the packet based at least in part on the UCI element.

Any one or more of the operations in FIG. 13 may be performed in a different order than shown and/or one or more of the operations may be performed concurrently in embodiments. Further, it should be understood that one or more of the operations may be omitted from and/or one or more additional operations may be added to the procedure 1300 in other embodiments.

It is well understood that the use of personally identifiable information should follow privacy policies and practices that are generally recognized as meeting or exceeding industry or governmental requirements for maintaining the privacy of users. In particular, personally identifiable information data should be managed and handled so as to minimize risks of unintentional or unauthorized access or use, and the nature of authorized use should be clearly indicated to users.

For one or more embodiments, at least one of the components set forth in one or more of the preceding figures may be configured to perform one or more operations, techniques, processes, or methods as set forth in the example section below. For example, the baseband circuitry as described above in connection with one or more of the preceding figures may be configured to operate in accordance with one or more of the examples set forth below. For another example, circuitry associated with a UE, base station, network element, etc. as described above in connection with one or more of the preceding figures may be configured to operate in accordance with one or more of the examples set forth below in the example section.

### EXAMPLES

In the following sections, further exemplary embodiments are provided.

Example 1 may include a method comprising determining an amount of delay of a packet received from a tethered device, determining whether the amount of delay satisfies a condition, and determining whether to apply special operation mode or default operation mode to transmission of the packet based at least in part on whether the amount of delay satisfies the condition.

Example 2 may include the method of example 1, wherein determining whether the amount of delay satisfies the condition includes determining whether the amount of delay exceeds a threshold value.

Example 3 may include the method of example 1, wherein determining whether to apply the special operation mode or the default operation mode includes determining an importance level associated with the packet, and determining whether to apply the special operation mode or the default operation mode based at least in part on the importance level associated with the packet.

Example 4 may include the method of example 1, wherein the condition is configured by a network, provided by the tethered device, provided by an application layer, provided by a core network, or configured by a user equipment implementation.

Example 5 may include the method of example 1, wherein determination of whether the amount of delay satisfies the condition is based on information provided by an application layer, information provided by the tethered device, information provided by a core network function, a time stamp received from the tethered device, or generalized precision time protocols (G-PTPs).

Example 6 may include the method of example 1, wherein determining whether the amount of delay satisfies the condition includes starting a count of a timer at an expected packet arrival time of the packet from the tethered device, determining whether the packet is received from the tethered device prior to expiry of the timer, and determining whether the amount of delay satisfies the condition based at least in part on whether the packet is received prior to the expiry of the timer.

Example 7 may include the method of example 6, wherein the packet is determined to be received prior to the expiry of the timer, and wherein the method further comprises stopping the timer upon receipt of the packet, determining the amount of delay based at least in part on a duration that the timer was counting until receipt of the packet, treating the amount of delay as zero, or determining that the default operation mode is to be applied to the transmission of the packet.

Example 8 may include the method of example 6, wherein the packet is determined to be received after the expiry of the timer, and wherein the method further comprises discarding the packet when the packet arrives, treating the packet as a delay-critical packet, triggering a delay status report (DSR) for a corresponding logical channel (LCH) or logical channel group (LCG), or determining that the special operation mode is to be applied to the packet.

Example 9 may include the method of example 1, wherein determining whether to apply the special operation mode or the default operation mode to transmission of the packet includes determining to apply the special operation mode to the packet, and wherein, based on the determination to apply the special operation mode to the packet, the method further comprises mapping the packet to a specific data resource bearer (DRB), discarding the packet, applying a special discard timer to the packet, treating the packet as a delay-critical packet data convergence protocol (PDCP) service data unit (SDU), submitting copies of the packet to multiple radio link control (RLC) entities, submitting the packet to a special RLC entity, prioritize or de-prioritize the order of submitting the packet to a lower layer, or adapting radio resource usage for transmission of the packet.

Example 10 may include the method of example 9, further comprising submitting the packet to the special RLC entity, wherein two or more RLC entities correspond to logical channels (LCHs) with different configurations, the two or more RLC entities including the special RLC entity, two or more RLC entities operate in different modes, the two or more RLC entities including the special RLC entity and the special RLC entity operating in unacknowledged mode (UM), or two or more RLC entities being associated with different medium access control entities (MAC) for different cell groups, the two or more RLC entities including the special RLC entity.

Example 11 may include the method of example 9, further comprising adapting the radio resource usage for transmission of the packet, wherein autonomous repetition using resources in a configured grant (CG) configuration is applied, autonomous repetition using resources in a different CG configuration is applied, or different physical layer (PHY) parameters to perform transmission of the packet are applied.

Example 12 may include the method of example 9, further comprising prioritizing or de-prioritizing the order of submitting the packet to a lower layer, wherein prioritizing or de-prioritizing the order of submitting the packet includes prioritizing an initial transmission of the packet over initial transmissions of other packets and retransmissions of other packets based at least in part on the determination to apply the special operation mode.

Example 13 may include the method of example 1, further comprising determining whether the amount of delay exceeds a threshold, and determining whether to autonomously utilize subsequent configured grant (CG) resources for repetition of the packet based at least in part on the determination of whether the amount of delay exceeds the threshold.

Example 14 may include the method of example 13, further comprising multiplexing an uplink control information (UCI) element with the packet for an initial transmission of the packet, wherein the UCI element indicates whether repetition will be performed for the packet on subsequent resources, whether remaining CG resources will be unused or used for other transmissions, whether redundancy versions of a transport block for the packet is to be transmitted in repetitions of the packet, or a value of a timer for one or more repetitions of the packet.

Example 15 may include a method comprising identifying a packet received from an upper layer of a tethered device, the packet to be forwarded to a network, determining an amount of delay of the packet from the tethered device, and determining whether to apply a special operation mode or a default operation mode to the packet for transmission of the packet to the network.

Example 16 may include the method of example 15, wherein determining whether to apply the special operation mode or the default operation mode includes determining whether the amount of delay exceeds a threshold.

Example 17 may include the method of example 15, wherein determining whether to apply the special operation mode or the default operation mode includes initiating a count of a timer at an expected packet arrival time for the packet, and determining whether the packet is received prior to an expiry of the timer.

Example 18 may include the method of example 15, wherein determining whether to apply the special operation mode or the default operation mode includes determining to apply the special operation mode to the packet, and wherein the method, based on the determination to apply the special operation mode, further comprises mapping the packet to a specific data resource bearer (DRB), discarding the packet, applying a special discard timer to the packet, treating the packet as a delay-critical packet data convergence protocol (PDCP) service data unit (SDU), submitting copies of the packet to multiple radio link control (RLC) entities, submitting the packet to a special RLC entity, or adapting radio resource usage for transmission of the packet.

Example 19 may include the method of example 15, further comprising determining whether the amount of delay exceeds a threshold, and determining whether to autonomously utilize subsequent configured grant (CG) resources for repetition of the packet based at least in part on the determination of whether the amount of delay exceeds the threshold.

Example 20 may include a method, comprising configuring a user equipment (UE) to determine whether to apply a special operation mode or a default operation mode to a packet received from a tethered device based at least in part on an amount of delay of the packet from the tethered device, and generating a transmission grant for transmission to the UE for forwarding the packet.

Example 21 may include the method of example 20, further comprising configuring the UE with information for determining the amount of delay or with one or more conditions for determining whether a condition is satisfied for applying the special operation mode.

Example 2 may include the method of example 20, further comprising identifying an uplink control information (UCI) element multiplexed with an initial transmission of the packet, and determining whether autonomous repetition is to be performed for the packet based at least in part on the UCI element.

Example 23 may include an apparatus comprising means to perform one or more elements of a method described in or related to any of examples 1-22, or any other method or process described herein.

Example 24 may include one or more non-transitory computer-readable media comprising instructions to cause an electronic device, upon execution of the instructions by one or more processors of the electronic device, to perform one or more elements of a method described in or related to any of examples 1-22, or any other method or process described herein.

Example 25 may include an apparatus comprising logic, modules, or circuitry to perform one or more elements of a method described in or related to any of examples 1-22, or any other method or process described herein.

Example 26 may include a method, technique, or process as described in or related to any of examples 1-22, or portions or parts thereof.

Example 27 may include an apparatus comprising: one or more processors and one or more computer-readable media comprising instructions that, when executed by the one or more processors, cause the one or more processors to perform the method, techniques, or process as described in or related to any of examples 1-22, or portions thereof.

Example 28 may include a signal as described in or related to any of examples 1-22, or portions or parts thereof.

Example 29 may include a datagram, information element, packet, frame, segment, PDU, or message as described in or related to any of examples 1-22, or portions or parts thereof, or otherwise described in the present disclosure.

Example 30 may include a signal encoded with data as described in or related to any of examples 1-22, or portions or parts thereof, or otherwise described in the present disclosure.

Example 31 may include a signal encoded with a datagram, IE, packet, frame, segment, PDU, or message as described in or related to any of examples 1-22, or portions or parts thereof, or otherwise described in the present disclosure.

Example 32 may include an electromagnetic signal carrying computer-readable instructions, wherein execution of the computer-readable instructions by one or more processors is to cause the one or more processors to perform the method, techniques, or process as described in or related to any of examples 1-22, or portions thereof.

Example 33 may include a computer program comprising instructions, wherein execution of the program by a processing element is to cause the processing element to carry out the method, techniques, or process as described in or related to any of examples 1-22, or portions thereof.

Example 34 may include a signal in a wireless network as shown and described herein.

Example 35 may include a method of communicating in a wireless network as shown and described herein.

Example 36 may include a system for providing wireless communication as shown and described herein.

Example 37 may include a device for providing wireless communication as shown and described herein.

Any of the above-described examples may be combined with any other example (or combination of examples), unless explicitly stated otherwise. The foregoing description of one or more implementations provides illustration and description, but is not intended to be exhaustive or to limit the scope of embodiments to the precise form disclosed. Modifications and variations are possible in light of the above teachings or may be acquired from practice of various embodiments.

Although the embodiments above have been described in considerable detail, numerous variations and modifications will become apparent to those skilled in the art once the above disclosure is fully appreciated. It is intended that the following claims be interpreted to embrace all such variations and modifications.

What is claimed is:

1. One or more non-transitory, computer-readable media having instructions that, when executed, cause processing circuitry to:
determine an amount of delay of a packet received from a tethered device;
determine whether the amount of delay satisfies a condition; and
determine whether to apply special operation mode or default operation mode to transmission of the packet based at least in part on whether the amount of delay satisfies the condition.

2. The one or more non-transitory, computer-readable media of claim 1, wherein to determine whether the amount of delay satisfies the condition includes to:
determine whether the amount of delay exceeds a threshold value.

3. The one or more non-transitory, computer-readable media of claim 1, wherein to determine whether to apply the special operation mode or the default operation mode includes to:
determine an importance level associated with the packet; and
determine whether to apply the special operation mode or the default operation mode based at least in part on the importance level associated with the packet.

4. The one or more non-transitory, computer-readable media of claim 1, wherein the condition is:
configured by a network;
provided by the tethered device;
provided by an application layer;
provided by a core network; or
configured by a user equipment implementation.

5. The one or more non-transitory, computer-readable media of claim 1, wherein determination of whether the amount of delay satisfies the condition is based on:
information provided by an application layer;
information provided by the tethered device;
information provided by a core network function;
a time stamp received from the tethered device; or
generalized precision time protocols (G-PTPs).

6. The one or more non-transitory, computer-readable media of claim 1, wherein to determine whether the amount of delay satisfies the condition includes to:
start a count of a timer at an expected packet arrival time of the packet from the tethered device;
determine whether the packet is received from the tethered device prior to expiry of the timer; and
determine whether the amount of delay satisfies the condition based at least in part on whether the packet is received prior to the expiry of the timer.

7. The one or more non-transitory, computer-readable media of claim 6, wherein the packet is determined to be received prior to the expiry of the timer, and wherein the instructions, when executed, further cause the processing circuitry to:
stop the timer upon receipt of the packet;
determine the amount of delay based at least in part on a duration that the timer was counting until receipt of the packet;
treat the amount of delay as zero; or
determine that the default operation mode is to be applied to the transmission of the packet.

8. The one or more non-transitory, computer-readable media of claim 6, wherein the packet is determined to be received after the expiry of the timer, and wherein the instructions, when executed, further cause the processing circuitry to:
discard the packet when the packet arrives;
treat the packet as a delay-critical packet;
trigger a delay status report (DSR) for a corresponding logical channel (LCH) or logical channel group (LCG); or
determine that the special operation mode is to be applied to the packet.

9. The one or more non-transitory, computer-readable media of claim 1, wherein to determine whether to apply the special operation mode or the default operation mode to transmission of the packet includes to determine to apply the special operation mode to the packet, and wherein, based on the determination to apply the special operation mode to the packet, the processing circuitry is to:
map the packet to a specific data resource bearer (DRB);
discard the packet;
apply a special discard timer to the packet;
treat the packet as a delay-critical packet data convergence protocol (PDCP) service data unit (SDU);
submit copies of the packet to multiple radio link control (RLC) entities;
submit the packet to a special RLC entity;
prioritize or de-prioritize an order of submitting the packet to a lower layer; or
adapt radio resource usage for transmission of the packet.

10. The one or more non-transitory, computer-readable media of claim 9, wherein the instructions, when executed, cause the processing circuitry to submit the packet to the special RLC entity, wherein:
two or more RLC entities correspond to logical channels (LCHs) with different configurations, the two or more RLC entities including the special RLC entity;
two or more RLC entities operate in different modes, the two or more RLC entities including the special RLC entity and the special RLC entity operating in unacknowledged mode (UM); or
two or more RLC entities being associated with different medium access control entities (MAC) for different cell groups, the two or more RLC entities including the special RLC entity.

11. The one or more non-transitory, computer-readable media of claim 9, wherein the instructions, when executed, cause the processing circuitry to adapt the radio resource usage for transmission of the packet, wherein:
autonomous repetition using resources in a configured grant (CG) configuration is applied;
autonomous repetition using resources in a different CG configuration is applied; or
different physical layer (PHY) parameters to perform transmission of the packet are applied.

12. The one or more non-transitory, computer-readable media of claim 1, wherein the instructions, when executed, further cause the processing circuitry to:
determine whether the amount of delay exceeds a threshold; and
determine whether to autonomously utilize subsequent configured grant (CG) resources for repetition of the packet based at least in part on the determination of whether the amount of delay exceeds the threshold.

13. A method comprising:
identifying a packet received from an upper layer of a tethered device, the packet to be forwarded to a network;
determining an amount of delay of the packet from the tethered device; and
determining whether to apply a special operation mode or a default operation mode to the packet for transmission of the packet to the network.

14. The method of claim 13, wherein determining whether to apply the special operation mode or the default operation mode includes determining whether the amount of delay exceeds a threshold.

15. The method of claim 13, wherein determining whether to apply the special operation mode or the default operation mode includes:
initiating a count of a timer at an expected packet arrival time for the packet; and
determining whether the packet is received prior to an expiry of the timer.

16. The method of claim 13, wherein determining whether to apply the special operation mode or the default operation mode includes determining to apply the special operation mode to the packet, and wherein the method, based on the determination to apply the special operation mode, further comprises:
mapping the packet to a specific data resource bearer (DRB);
discarding the packet;
applying a special discard timer to the packet;
treating the packet as a delay-critical packet data convergence protocol (PDCP) service data unit (SDU);
submitting copies of the packet to multiple radio link control (RLC) entities;
submitting the packet to a special RLC entity; or
adapting radio resource usage for transmission of the packet.

17. The method of claim 13, further comprising:
determining whether the amount of delay exceeds a threshold; and
determining whether to autonomously utilize subsequent configured grant (CG) resources for repetition of the packet based at least in part on the determination of whether the amount of delay exceeds the threshold.

18. An apparatus, comprising:
processing circuitry to:
configure a user equipment (UE) to determine whether to apply a special operation mode or a default operation mode to a packet received from a tethered device based at least in part on an amount of delay of the packet from the tethered device; and
generate a transmission grant for transmission to the UE for forwarding the packet; and
interface circuitry coupled with the processing circuitry, the interface circuitry to enable communication.

19. The apparatus of claim 18, wherein the processing circuitry is further to:
configure the UE with information for determining the amount of delay or with one or more conditions for determining whether a condition is satisfied for applying the special operation mode.

20. The apparatus of claim 18, wherein the processing circuitry is further to:
identify an uplink control information (UCI) element multiplexed with an initial transmission of the packet; and
determine whether autonomous repetition is to be performed for the packet based at least in part on the UCI element.
